(19) United States
(12) Patent Application Publication
(10) Pub. No.: US 2006/0111113 A1
(43) Pub. Date: May 25, 2006

(54) Virtual private network with mobile nodes

(76) Inventor: Heikki Waris, Helsinki (FI)

Correspondence Address: HARRINGTON & SMITH, LLP, 4 RESEARCH DRIVE, SHELTON, CT, 06484-6212, US

(21) Appl. No.: 10/531,491

(22) PCT Filed: Dec. 30, 2002
(86) PCT No.: PCT/IB02/05733

§ 371 Date: Nov. 14, 2005

(30) Foreign Application Priority Data
Oct. 17, 2002 (WO) PCT/IB02/04295

(51) Int. Cl. H04Q 7/20

(52) U.S. Cl. 455/441

(57) ABSTRACT

A virtual private network has an internal secured portion which connects to an external portion, the network via at least a first gateway and via a second gateway. There are a plurality of workstations including at least one mobile workstation in the external portion. The network automatically changes the point through which the mobile workstation communicates with the internal portion of the network from the first gateway to the second gateway, in response to movement of the mobile workstation. Context information is transferred to the second gateway. The context information includes an identifier of the mobile workstation and may also include material for defining secure communication means by which information is transferable securely between the mobile workstation in the external portion of the network and the internal portion of the network, via the second gateway.

Embodiments of the present invention relate to a virtual private network capable of having a plurality of mobile nodes, to the components of the network and to the methods and processes used within the network.

A Virtual Private Network (VPN) provides a network-like connection via a public network, such as the internet. Remote components of the VPN appear to a user as if they are physically connected via dedicated communication cables, when in fact the public network may form at least part of the connection between them.

As the VPN may use a public network, security measures must be taken to prevent unauthorised users hacking into the VPN. The Internet Engineering Task Force (IETF) has developed the Internet Protocol Security (IPsec) standard, which is suitable for securing the VPN. The IPsec standard specifies an extension to TCP/IP that utilizes data encryption and digital encryption technology to positively identify a user or network component. Implementation of IPsec, or an equivalent security protocol, on a VPN results in a Secure Virtual Private Network (SVPN).

The VPN is a packet switching network in which data is sent as packets. Each packet has a data payload and a header. The header includes the address of the origin of the data and the address of the destination of the data. The addresses used may be public IP addresses or private IP addresses. A public address is a globally unique address, whereas a private address is unique in the VPN but not necessarily globally.

A SVPN has a Security Gateway placed at the interface between a private secured network and the public unsecured network. The private secured network forms an internal portion of the VPN, whereas those parts of the VPN which are part of the public network are external portions of the VPN.

A Security Association (SA) is a context defining a virtual simplex connection between two end points that affords security services to the traffic carried between those end points. To secure bi-directional communication between two nodes, two Security Associations (one in each direction) are required in both nodes. Among other things each context indicates an authentication and/or encryption algorithm and a secret (a shared key, or appropriate public/private key pair).

Each node of a SVPN has a Security Policy Database (SPD) and a Security Association Database (SAD). The SPD specifies the treatment of every inbound and outbound packet. It also indicates which SA or SA bundle in SAD should be used, if any. The SPD maps traffic to a SAD entry, which has the SA parameters for the traffic. The Encapsulating Security Payload (ESP) [RFC2406] is one type of Security Association and it provides confidentiality, data origin authentication, connectionless integrity, anti-replay service and limited traffic flow confidentiality.

At present, when a user of a VPN ‘roams’ to a distant external portion of the VPN, typically, (s)he accesses the VPN by directly dialing into a security gateway. Thus the connection to the VPN is made via a separate circuit switched connection of the user's choice. This is not very easy for a user to administer and the user must manually select the preferred connection point to the VPN.

It would be desirable to provide for a roaming user to access the VPN without having to establish a circuit switched connection to a particular security gateway.

It would be desirable to provide a solution, in which routing is automatically optimized, preferably using IPv6.

According to one aspect of the present invention there is provided a virtual private network including an internal secured portion which connects via at least a first gateway and a second gateway to an external portion, the network comprising: a plurality of workstations including at least one mobile workstation in the external portion; the first gateway; the second gateway; and means for automatically changing the point through which the mobile workstation communicates with the internal portion of the network from the first gateway to the second gateway, in response to movement of the mobile workstation.

According to another aspect of the invention there is provided a method of optimizing the route by which information travels between a mobile node in an external portion of a network and a correspondent node in an internal portion of a network, comprising the steps of: determining when a first serving gateway through which the mobile node communicates with the internal portion of the network, is sub-optimal; identifying a second gateway; and transferring the point through which the mobile node communicates with the internal portion of the network from the first serving gateway to the second gateway.

According to a further aspect of the invention there is provided a mobile workstation for connecting to an external portion of a network that includes an internal secured portion connected, via a first gateway and a second gateway to the external portion, comprising: means arranged to receive, via the first secure communication means, an identifier of a second gateway; and means arranged to change from communicating with the internal portion of the network through the first gateway to communicating via the second gateway.

Embodiments of the invention provide for the easy and automatic change of a SG during a session, particularly between SG is remote segments of a VPN. This works automatically on the IP layer and provides optimised routing. This reduces any delays associated with key generation and exchange.

For a better understanding of the present invention reference will now be made by way of example only to the accompanying drawings in which

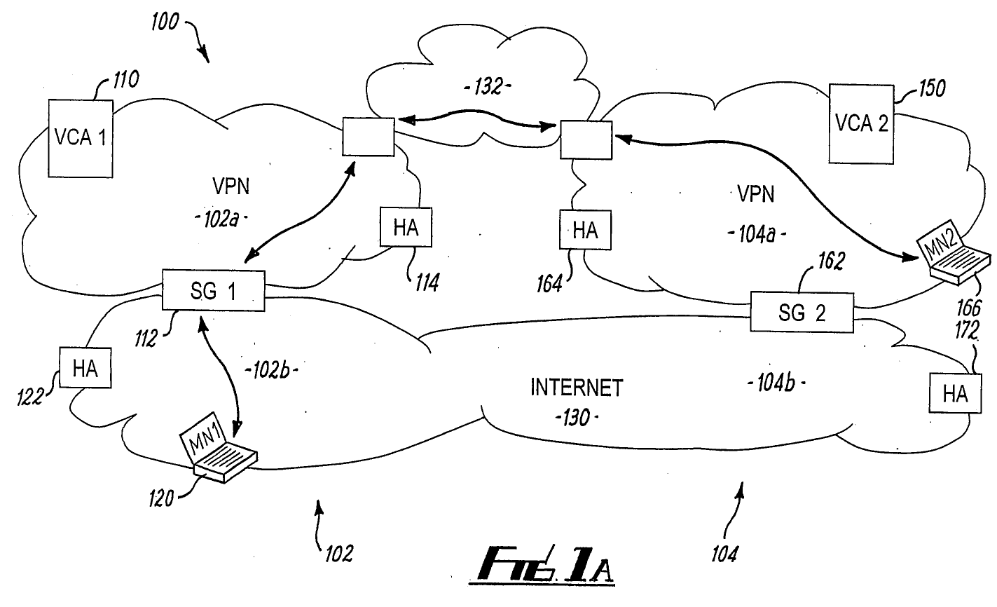

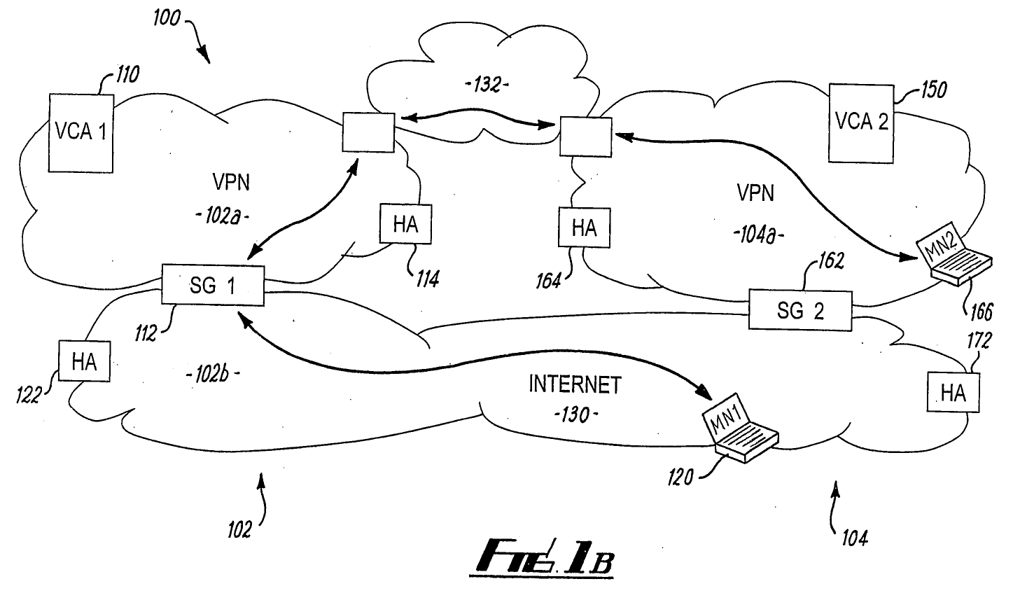

FIG. 1A illustrates a virtual private network in which MN1 is located near to SG1 and communicates via SG1;

FIG. 1B illustrates a virtual private network after MN1 has moved away from SG1 towards SG2 but continues to communicate via SG1;

FIG. 1C illustrates a virtual private network in which MN1, located near to SG2, communicates via SG2; and

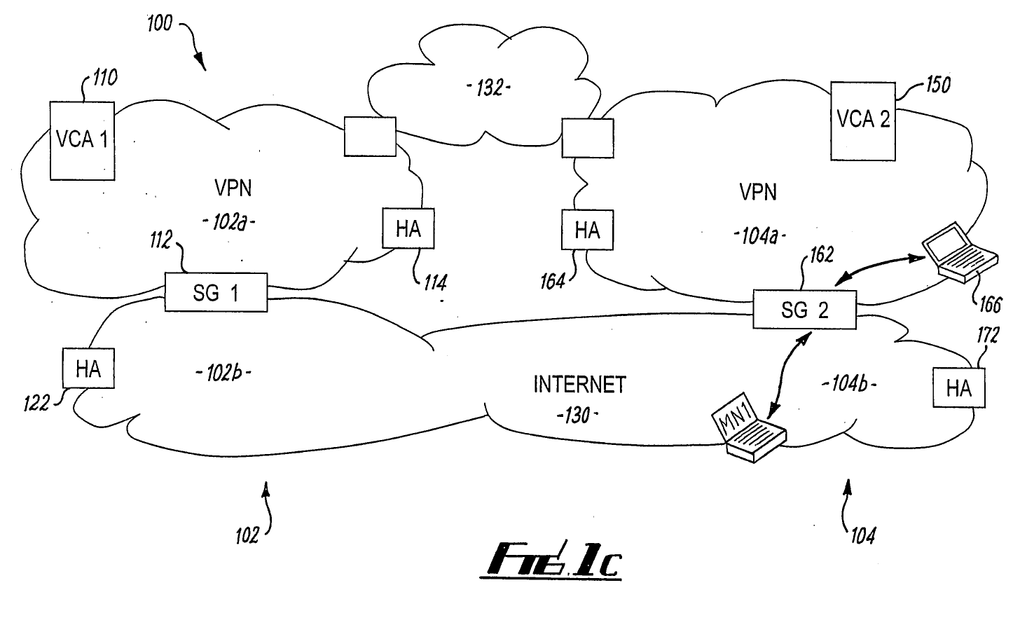

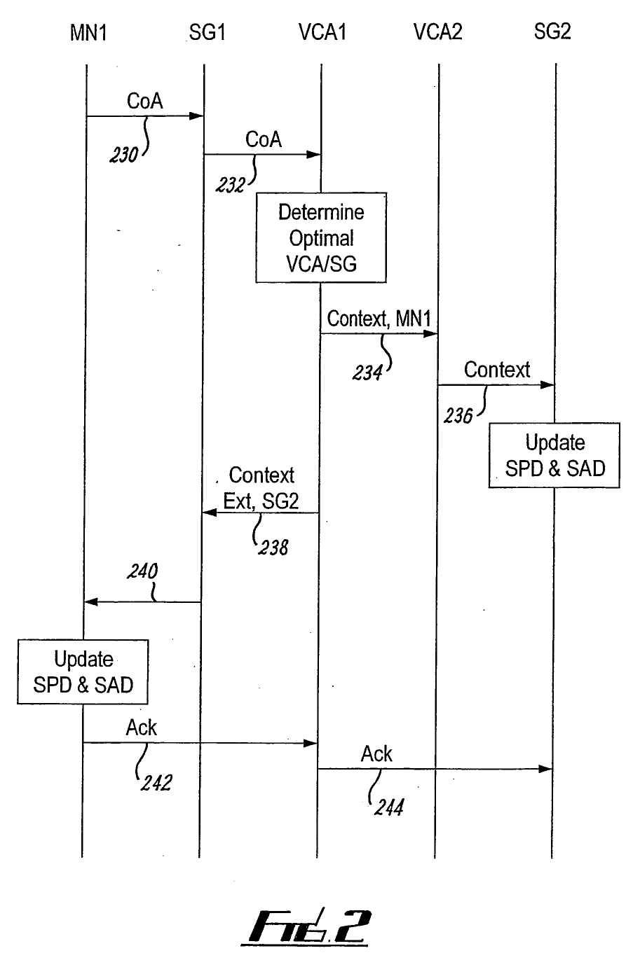

FIG. 2 illustrates the signaling that allows MN1 to switch from communicating via SG1 to communicating via SG2.

Referring to FIG. 1A, the virtual private network (VPN) 100, comprises a first segment 102 and a second segment 104. The first and second segments are connected via a leased-line connection or the Internet 132.

The first segment 102 serves a particular geographical or network-topological area. It comprises an internal portion 102a and an external portion 102b. The internal portion 102a comprises a first VPN Certificate Authority (VCA1) 110, at least a first security gateway (SG1) 112, and an internal Home Agent (HA) 114. The first security gateway(s) (SG1) 112 mediate between the internal portion 102a and the external portion 102b. The external portion 102b comprises a first mobile node (MN1) 120, and an external home agent (HA) 122. A non-secure communications medium 130, such as the internet, interconnects the first mobile node (MN1) 120, the external HA 122 and SG1 112.

The external home agent 122 manages the external home address (HoA) of MN1, which is visible in the external portion of the VPN. The internal home agent 114, which is present only if the VPN uses private addresses, manages the internal HoA of MN1, which is visible to the internal portion of the VPN.

The second segment 104 serves a particular geographical or network-topological area, different to that served by the first segment 102. It comprises an internal portion 104a and an external portion 104b. The internal portion 104a comprises a second VPN Certificate Authority (VCA2) 150, at least a second security gateway (SG2) 162, an internal Home Agent (HA) 164 and at least one correspondent node (CN) for MN1. In this example, the CN is a second mobile node (MN2) 166. The security gateway(s) (SG2) mediate between the internal portion 102a and the external portion 102b. The external portion 104b comprises an external home agent (HA) 172 interconnected to the second security gateway (SG2) 162 by the non-secure communications medium 130.

MN1 120 has two security associations (uplink and downlink) with SG1 112 and two security associations (uplink and downlink) with VCA 1 110. There are also two security associations (uplink and downlink) between VCA 1 110 and SG1 112. There are also two security associations (uplink and downlink) between VCA2 150 and SG2 162. These security associations (SA) are Encapsulating Security Payload Security Associations (ESP SA). They are encrypted channels for communication.

Although the VCA has been described as a separate entity to the SG, it would be possible to integrate them. There are, however, advantages to having them as distinct entities. When the defense is in one layer (SG only), as opposed to two layers (VCA & SG), the attacker only needs to break into one SG in order to severely affect the VPN service. Also, if the VCA function is integrated into each SG, then where a segment has several SGs all of them need to have this extra functionality. This proliferation may increase the operating costs of the system.

A mobile node (MN), security association (SA), Encapsulating Security Payload (ESP), home agent (HA), security gateway (SG) and correspondent node (CN) are terms well understood by a person knowledgeable in Virtual Private Networks, Internet Protocol Security (Ipsec) Protocol and Mobile Internet Protocol version 6 (MIPv6).

The VPN Certificate authority (VCA) is a newly devised component of a VPN and the security associations between VCA1 110 and MN1 are newly implemented security associations.

If necessary, MN1 executes a Binding Update with SG1. Therefore SG1 maps the external HoA of MN2 to the external CoA of MN2 and tunnels packets addressed for MN1 from the internal portion 102a to the external CoA of MN2 in the external portion 102b.

FIG. 1A illustrates a VPN 100, in which MN1 120 is in session with CN 166, which in this example is MN2. MN1 is in the external portion 102b of the first segment 102 of the VPN 100 and MN2 is in the internal portion 104a of the second segment 104. The MN1 120 uses its existing ESP SAs with the SG1 112 to communicate with the internal portions 102a, 104a of the VPN. The SG1 receives an encapsulated packet from MN1 via this ESP SAs, decapsulates it and routes it to the CN 166.

Thus when a VPN Mobile Node (MN1 120) using ESP Security Associations (SAs) moves to a new location (FIG. 1B), the ESP tunnel end point in the Security Gateway (SG1 112) is no longer the closest or optimal point of attachment to the VPN 100, especially if MN1 has sessions with a node (MN2) close to its current location in the network topology. This is inefficient. The optimum path for communication between MN1 120 and MN2 166 in FIG. 1B would be via SG2 162.

In order to optimise the route, the first VPN segment 102 from which MN1 moved and the second VPN segment 104 to which it moved cooperate to move the context of MN1 to the new location. This context consists of at least the HoA of MN1, but should also include key material for the creation of new ESP SAs between MN1 and the optimal security gateway (SG2 162). The context information is managed by a set of separate VPN Certificate Authorities (VCA1 and VCA2). It is moved from SG1 via VCA1 to the VCA2 and onto the SG2. However, before this movement, the identity of the target SG/VCA must be resolved.

Thus there is a “hand-over” between a first security gateway (SG1 112) in a first segment 102 and a second security gateway (SG2 162) in a second segment 104 which optimizes the routing of traffic. MN1 then communicates, after the hand-over, with SG2 162 as illustrated in FIG. 1C.

The process of hand-over will now be described in more detail with reference to FIG. 2.

MN1 and MN2 (not shown) are in session. Initially, MN1 communicates with MN2 via SG1 as illustrated in FIG. 1A. MN1 moves so that it is close to SG2, as illustrated in FIG. 1B.

MN1 detects when it has moved close to another possible node at which to link into the VPN and informs VCA1. One mechanism for achieving this, is to detect the prefix information in advertisement messages multicast from the node. When a change is detected, MN1 obtains a new external CoA using stateless or stateful address autoconfiguration. It then performs a binding update with its HA and SG1. Thus the new external CoA of MN1 is sent 230 to SG1.

The external CoA of MN1 has therefore changed at this point, but MN1 is still communicating via SG1.

SG1 provides 232 the new location data (e.g. external CoA) for MN1 to the VCA1 using the downlink ESP SA between SG and VCA.

VCA1 updates a location database, which is used to automatically resolve whether MN1 is using the optimal SG or whether there should be a hand-over to another SG. The location database associates a responsible infrastructure node (VCA and/or SG) with a location. The ‘location’ may be address-space related, geographical or topological. The location database can be local or remote. Thus querying the database with the new external CoA of MN1 may return the present VCA/SG or a new optimal VCA/SG.

When a new optimal VCA/SG has been identified which is in a different segment, VCA1 automatically sends 234 the context of MN1 to the VCA of the optimal segment (VCA2). The VCAs can communicate with AAA attribute-value-pairs (AVP) between segments, and the VCA functionality can be combined with AAA infrastructure. The information sent may additionally identify the location of MN1 so that VCA2 can determine the optimal SG.

When a new optimal SG has been identified which is in the same segment, VCA1 automatically sends the context of MN1 to the optimal SG (not shown in FIG. 2).

The context information includes at least an identifier of MN1 (its external HoA) and should also includes secret material for setting up ESP SAs between the new SG and MN1. The secret material should not be the same as that used for the ESP SAs between MN1 and SG1 or may extend that context and provide new secret material for new ESP SAs between SG2 and MN1. The context information is sent to the new SG/VCA.

As context information is already being transferred to SG2, it is a very little extra cost to include new secret material (e.g. keys, better/faster crypto algorithm etc.) as well. This improves security.

The MN context information is protected with the VPN owner's root certificate. All parties have the capability of reliably verifying something that has been certified by the VPN owner (protected by its certificate). Without this, they would have to trust some other node that only claims to be authoritative, giving rise to the possibility of masquerading attacks.

VCA2 sends 236 the context information to SG2 using an ESP SA between SG2 and VCA2.

SG2 updates its SPD database and SAD database. An SPD policy forwards packets to the HoA of MN1 onwards to the appropriate link, which is the downlink ESP SA from SG2 to MN1. The SAD defines the appropriate ESP SA. The ESP SA tunnel uses MN1's external HoA.

CA1 commands 238 SG1 using one of the ESP SAs between VCA1 and SG1 to automatically send 240 to MN1 any extension to MN1's context and the address of SG2.

The MN1 receives the secret(s) extending its context, if any, and the address of SG2. It enters into its Security Association Database (SAD) a new ESP SA to SG2 and a new ESP SA from SG2. Each entry specifies the algorithm to be used and the secret(s) to be used. MN1 modifies its Security Policy Database (SPD) so that traffic destined for MN2 will be encrypted using the first SA of the new SA pair and traffic from the MN2 will be decrypted using the second SA of the new SA pair. MN1 then sends 242 an Acknowledgement message to VCA1 which forwards 244 it to SG2.

In the example of FIG. 2, the updating of the SPD and SAD at SG2 is illustrated as occurring before the updating of the SPD and SAD at MN1. Thus the context is sent to the VCA2 (step 234) before it is sent to the SG1 (step 238). This timing is, however, only illustrative. For example, the updating of the SPD and SAD at MN1 may precede the updating of the SPD and SAD at MN1. Thus the context is sent to the SG1 before it is sent to the VCA2. The acknowledgement, in this situation, is sent from the SG2 to the MN1 via the VCA1.

MN1 creates new SAs with VCA2 and starts using SG2 and VCA2 instead of its SG1 and VCA1. In MN1, the packets sent to the session destination MN2 are simply put to the new ESP SA (to SG2) by the SPD.

The internal HA 114 or external HA 122 of MN1 do not change when the serving SG changes from SG1 to SG2.

Movement of MN1 within external portion 104b will result in further changes to the external CoA of MN1 but not until the hand-over between SGs is complete.

If internal addresses are used in the VPN, the MN1 receives router advertisements from SG2 after establishing the new ESP SAs with it and allocates to itself a new internal CoA. It then performs return routability and binding procedures with this new internal CoA. MN1 needs to maintain its connection to the SG1 at least until the binding with its internal HA 114 is in place. Thus MN1 may conserve connectivity to SG1 with its original internal CoA at the same time asit has a new CoA. This is a form of ‘phased handover’ in which MN1 is capable of communicating with both SG1 and SG2.

Each VPN segment has only one VCA but possibly several SGs. Each SG is subject to the VCA of its segment (with implied management and trust relationships). According to the present example, the VCA controls all hand-overs between SGs whether or not they are in the same segment as the VCA, using additional VCAs if necessary. This is advantageous, because it is easier for a VCA to know (and maintain a relationship of trust with) a small set of VCAs than a large set of SGs. However, in other examples, the VCA may only control hand-overs between SGs which are in different segments to it and each SG control the transfer of a context to another SG within the same segment as the VCA.

The mobile node MN1 may be any suitably configured mobile workstation such as a lap-top computer, a personal digital assistant or a cellular mobile telephone

Although embodiments of the present invention have been described in the preceding paragraphs with reference to various examples, it should be appreciated that modifications to the examples given can be made without departing from the scope of the invention as claimed. For example, although the above description refers to the transfer of communication between MN1 and the CN MN2 from using SG1 to using SG2, it is still possible for MN1 to communicate with a different CN using SG1. That is the contexts transferred from SG1 to SG2 are not all the contexts of MN1 but those for a CN located in the segment of SG2.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A virtual private network including an internal secured portion which connects via at least a first gateway and a second gateway to an external portion, the network comprising:
a plurality of workstations including at least one mobile workstation in the external portion;
the first gateway;
the second gateway; and
means for automatically changing the point through which the mobile workstation communicates with the internal portion of the network from the first gateway to the second gateway, in response to movement of the mobile workstation.

2. A network as claimed in claim 1, further comprising transfer means for transferring context information usable by a gateway in communications with the mobile workstation, to the second gateway.

3. A network as claimed in claim 2, wherein the context information includes an identifier of the mobile workstation.

4. A network as claimed in claim 3 wherein the identifier is the home address of the mobile workstation.

5. A network as claimed in claim 2, wherein the context information includes material for defining secure communication means by which information is transferable securely between the mobile workstation in the external portion of the network and the internal portion of the network, via the second gateway.

6. A network as claimed in claim 5, wherein the secure communication means is a security association pair between the second gateway and the mobile workstation.

7. A network as claimed in claim 2, wherein the transfer means is physically separate from the first gateway.

8. A network as claimed in claim 2, wherein the transfer means additionally transfers information to the mobile workstation for enabling communications between the mobile workstation and the second gateway.

9. A network as claimed in claim 8 wherein the information transferred to the mobile workstation enables secure communication means by which information is transferable securely between the mobile workstation in the external portion of the network and the internal portion of the network, via the second gateway.

10. A network as claimed in claim 9, wherein the secure communication means is a security association pair between the mobile workstation and the second gateway.

11. A network as claimed in claim 8, wherein the information transferred to the mobile workstation comprises the address of the second gateway.

12. A network as claimed in claim 8, wherein the information transferred to the mobile workstation is transferred between the first gateway and the mobile workstation using an existing security association between the mobile workstation and the first gateway.

13. A network as claimed in claim 1 wherein the second gateway comprises one or more databases which are updated to enable the internal portion of the network and the mobile workstation in the external portion of the network to communicate via the second gateway.

14. A network as claimed in claim 13, wherein the one or more databases are a Security Policy Database and a Security Association Database.

15. A network as claimed in claim 1 wherein the mobile workstation comprises one or more databases which are updated to enable the internal portion of the network and the mobile workstation in the external portion of the network to communicate via the second gateway.

16. A network as claimed in claim 15, wherein the one or more databases are a Security Policy Database and a Security Association Database.

17. A network as claimed in claim 1 further comprising location detection means for detecting the location of the mobile workstation and initiating a change in the point through which the mobile workstation communicates with the internal portion of the network, from the first gateway to a better gateway.

18. A network as claimed in claim 17, wherein the gateway is better because it is closer to the mobile workstation and/or it is optimal for routing existing sessions.

19. A network as claimed in claim 17, wherein the detection means is responsive to a location identifier received from the mobile workstation.

20. A network as claimed in claim 19, wherein the location identifier is the care-of-address of the mobile workstation.

21. A network as claimed in claim 20, wherein the identifier is received during a mobility binding update.

22. A network as claimed in claim 17, wherein the location detection means is separate from the first gateway.

23. A network as claimed in claim 22, wherein the transfer means is physically separate from the first gateway and wherein the location detection means and transfer means are housed together.

24. A network as claimed in claim 1 wherein the first gateway and the second gateway are in distinct physically separated segments of the network.

25. A network as claimed in claim 1, wherein the mobile workstation communicates with the internal portion of the network via the first gateway and also via the second gateway simultaneously for a transition period, before communicating via the second gateway only.

26. A network as claimed in claim 1 wherein the mobile workstation is involved in a session with a correspondent node.

27. A network as claimed in claim 26, wherein the correspondent node is located in the internal portion of the network and the mobile workstation is located in the external portion of the network.

28. A method of optimizing the route by which information travels between a mobile node in an external portion of a network and a correspondent node in an internal portion of a network, comprising the steps of:
determining when a first serving gateway through which the mobile node communicates with the internal portion of the network, is sub-optimal;
identifying a second gateway; and
transferring the point through which the mobile node communicates with the internal portion of the network from the first serving gateway to the second gateway.

29. A mobile workstation for connecting to an external portion of a network that includes an internal secured portion connected, via a first gateway and a second gateway to the external portion, comprising:
means arranged to receive, via the first secure communication means, an identifier of a second gateway; and
means arranged to change from communicating with the internal portion of the network through the first gateway to communicating via the second gateway.

30. A mobile workstation as claimed in claim 23, further comprising means for using a first secure communication means by which information is transferable securely between the internal portion of the network and the mobile workstation via the first gateway, to receive the identifier of the second gateway;

31. A mobile workstation as claimed in claim 23, further comprising means for using a second secure communication means to transfer information securely between the internal portion of the network and the mobile workstation via the second gateway;

32. (canceled)

33. (canceled)

34. (canceled)
